(19) United States
(12) Patent Application Publication
(10) Pub. No.: US 2009/0086806 A1
(43) Pub. Date: Apr. 2, 2009

(54) TIME VARYING EQUALIZATION

(75) Inventors: Chien-Meen Hwang, San Jose, CA (US); Ann P. Shen, Saratoga, CA (US)

Correspondence Address: FISH & RICHARDSON P.C., P.O. BOX 1022, MINNEAPOLIS, MN, 55440-1022, US

(73) Assignee: NANOAMP SOLUTIONS INC. (CAYMAN), Santa Clara, CA (US)

(21) Appl. No.: 12/199,092

(22) Filed: Aug. 27, 2008

Related U.S. Application Data
(60) Provisional application No. 60/975,768, filed on Sep. 27, 2007.

(51) Int. Cl. H04L 27/01

(52) U.S. Cl. 375/232

(57) ABSTRACT

In some implementations, a signal is received at a device and a gain change is detected in a component of the device that affects the signal. A state of an equalizer is adjusted in response to the detected gain change to a first state that reduces transient effects introduced into the signal by one or more components in the device as a result of the gain change. The signal is equalized using the equalizer with the state set to the first state and the state of the equalizer is adjusted from the first state to a second state while equalizing the signal using the equalizer such that the second state passes the signal through the equalizer substantially unchanged.

### CROSS REFERENCE TO RELATED APPLICATIONS

This application claims the benefit of priority from U.S. Provisional Application entitled “TIME VARYING EQUALIZATION”, Application No. 60/975,768 filed Sep. 27, 2007, the disclosure of which is incorporated by reference.

### TECHNICAL FIELD

This disclosure relates to the processing and transmission of data in radio frequency communications.

### BACKGROUND

Often it is desirable to remove transient effects in a radio frequency (RF) receiver system. An equalizer can be used in RF receiver circuits to remove the transient effects.

### SUMMARY

Generally, implementations can involve configuring a time varying equalizer placed after a gain stage to mitigate transient effects from an abrupt gain change. In addition, the techniques described here can be compatible with digital algorithms used in communication systems. The techniques set forth in the present disclosure can, for example, provide for reducing distortion due to the transient response of a gain change.

According to one general aspect, a method comprises receiving a signal at a device and detecting a gain change in a component of the device that affects the signal. The method also includes adjusting a state of an equalizer in response to the detected gain change to a first state that reduces transient effects introduced into the signal by one or more components in the device as a result of the gain change. The method further includes equalizing the signal using the equalizer with the state set to the first state and adjusting the state of the equalizer from the first state to a second state while equalizing the signal using the equalizer such that the second state passes the signal through the equalizer substantially unchanged.

These and other implementations can optionally include one or more of the following features. For example, the first and second states of the equalizer can be associated with first and second sets of equalizer coefficients, respectively. The method can include maintaining, before the detected gain change, the equalizer at an initial state such that the gain value of the first state is higher than a gain value of the initial state. The first and second states can be determined from values stored in an equalizer state table. The first and second states can be calculated dynamically. The equalizer can be a digital or an analog filter. The first state of the equalizer can reduce transient effects introduced into the signal by a filter before the signal is equalized by the equalizer.

Also, adjusting the state of the equalizer to the first state in response to the detected gain change can include detecting a gain change in a component that affects the signal continuously, at intervals, or at specific circumstances. Detecting the gain change in the component that affects the signal can include detecting a gain change instruction from a baseband. Detecting the gain change in the component that affects the signal can include monitoring the component that affects the signal for a change of gain.

Further, adjusting the state of the equalizer from the first state to a second state can include maintaining the state at the first state for a first time period and maintaining the state at the second state until detecting a gain change in a component that affects the signal. Adjusting the state of the equalizer from the first state to the second state can include adjusting the state from the first state to a first intermediate state, maintaining the state at the first intermediate state for a second time period, adjusting the state from the first intermediate state to a second intermediate state, and maintaining the state at the second intermediate state for a third time period. The first, second, and third time periods can be determined from values stored in a time period table. Adjusting the state of the equalizer from the first state to a second state can include adjusting the state to one or more intermediate states and adjusting the state from the one or more intermediate states to the second state, the one or more intermediate states having one or more gain values between a gain value of the first state and a gain value of the second state. The one or more intermediate states can reduce transient effects which have a smaller magnitude than the transient effects reduced by the first state.

According to a second general aspect, a system comprises an amplifier configured to amplify an input signal and a filter coupled to the amplifier and configured to filter an amplified signal. The system also includes an equalizer coupled to an output of the filter. The system further includes a control circuit configured to detect a gain change in the amplifier, adjust a state of the equalizer in response to the detected gain change to a first state that reduces transient effects introduced into the signal by one or more components as a result of the gain change, and adjust the state of the equalizer from the first state to a second state while the signal is equalized using the equalizer such that the second state passes the signal through the equalizer substantially unchanged.

These and other implementations can optionally include one or more of the following features. For example, the control circuit can be configured to adjust the state from an initial state to the first state such that a gain value of the first state is higher than a gain value of the initial state. The adjustment of the state from the initial state to the first state can be in response to a gain change being detected. The control circuit can be configured to detect a gain change instruction from a baseband. The control circuit can be configured to monitor the component that affects the signal for a change of gain. The control circuit can be configured to detect a gain change in the amplifier continuously, at intervals, or at specific circumstances.

Also, the control circuit can be configured to adjust the state to one or more intermediate states comprising one or more intermediate gain values and adjust the state from the one or more intermediate states to the second state such that one or more intermediate gain values of the one or more intermediate states are between a gain value of the first state and a gain value of the second state. The one or more intermediate states can reduce transient effects which have a smaller magnitude then the transient effects reduced by the first state. The control circuit can be configured to maintain the state at the first state for a first time period and maintain the state at the second state until detecting a gain change in a component that affects the signal. The control circuit can be configured to adjust the state from the first state to a first intermediate state, maintain the state at the first intermediate state for a second time period, adjust the state from the first intermediate state to a second intermediate state, and maintain the state at the second intermediate state for a third time period. The control circuit can be configured to determine the first, the second, and the third time periods from values stored in a time period table. The control circuit can be configured to determine the first and second states from values stored in an equalizer state table. The first and second states of the equalizer can be associated with first and second sets of filter coefficients, respectively. The equalizer can analog filter.

According to a third general aspect, a receiver comprises an antenna configured to receive a signal and a radio frequency filter configured to filter the signal. The receiver also includes a low noise amplifier configured to amplify the filtered signal and a mixer configured to mix output of the low noise amplifier. The receiver further includes an analog-to-digital converter configured to convert the signal after it has been mixed. In addition, the receiver includes a digital signal processor configured to receive the converted signal and configured to equalize the converted signal as a digital equalizer, detect a gain change in a component that affects the signal, adjust a state of the digital equalizer in response to the detected gain change to a first state that reduces transient effects introduced into the signal by one or more components in the receiver as a result of the gain change, and adjust the state of the digital equalizer from the first state to a second state while the signal is equalized using the digital equalizer such that the second state passes the signal through the equalizer substantially unchanged.

These and other implementations can optionally include one or more of the following features. For example, the digital signal processor can be configured to adjust the state from an initial state to the first state such that a gain value of the first state is higher than a gain value of the initial state. The digital signal processor can be configured to adjust the state to one or more intermediate states comprising one or more intermediate gain values and adjust the state from the one or more intermediate states to the second state, the one or more gain values of the one or more intermediate states being between a gain value of the first state and a gain value of the second state. The one or more intermediate states can reduce transient effects which have a smaller magnitude then the transient effects reduced by the first state. The digital signal processor can be configured to determine the first and second states from values stored in an equalizer state table.

According to a fourth general aspect, a method comprises receiving a signal at a device with an equalizer and detecting a gain change in a component of the device that affects the signal. The method also includes adjusting a state of the equalizer to a first state in response to the detected gain change and equalizing the signal using the equalizer with the state set to the first state. The method further includes adjusting the state of the equalizer from the first state to a second state while equalizing the signal using the equalizer such that a gain value of the second state is less than a gain value of the first state.

### DESCRIPTION OF THE DRAWINGS

FIG. 1 is a block diagram of an example of a process for adjusting a time varying equalizer.

FIG. 2 is a flow chart of an example of a process for adjusting a time varying equalizer.

FIGS. 3A and 3B are schematics illustrating examples of circuits with time varying equalizers.

FIG. 4 is a schematic of an example of a low intermediate frequency (IF) receiver with a time varying equalizer.

FIG. 5 is a schematic of an example of a direct-conversion receiver with time varying equalizers.

FIG. 6 is a flow chart of an example of a process for adjusting a time varying equalizer

### DETAILED DESCRIPTION

In order to compensate for signal amplitude variation in RF communication systems, the automatic gain control (AGC) gain can be adjusted while a signal is being received and/or processed. The gain change stage can include a low noise amplifier (LNA) and/or any other amplifiers placed before a filter, such as, for example, an anti-aliasing filter. The abrupt change of the gain of a system component such as an amplifier can create transient behavior in the filter coupled to the output of the amplifier. This transient behavior can introduce signal distortion in the output signal of the filter.

By placing a time varying equalizer after or before the filter, the transient effects from the gain change can be diminished, and, thus, the filtered signal distortion can be reduced or minimized. In particular, the equalizer can initially be configured to reverse the transient effect and the resultant signal distortion after a gain change of, for example, an amplifier, a mixer, or an analog to digital converter (ADC). The equalizer then can gradually change its response to eventually reach a filter configuration that has little or no impact on the wanted signal. Thus, the equalizer can be configured to reverse a larger transient effect of the signal when the gain change is detected, and, in varying or continuous steps, can be gradually adjusted to reduce the less prominent signal distortion as the transient effects diminish. Finally, the equalizer can be adjusted to an all band-pass state for the filtered steady state signal to pass through the equalizer.

In a more specific example, when a gain change occurs, the time varying equalizer can be configured to reverse the effects of signal distortion from a filter (e.g. a low-pass filter) placed after the gain change component with a filter transient response due to the component gain change (e.g., the time varying equalizer implements a high-pass filter to compensate for effects from a low-pass filter). Thus, a combination of the filter after the gain change and the equalizer acts as an all-pass filter to the input signal to the filter without generating the transient response. The time varying equalizer is then changed to an all-pass filter as the filter after the gain change component gradually settles to a steady state without transient effects, such that the equalizer does not have a significant effect on the filtered signal output from the filter after the gain stage. The time varying equalizer can stay in the steady state of all-pass until the next gain change is detected. This can mitigate the transient effects that occur from the gain change and simplify the gain stage of analog amplifier designs.

Also, in various implementations, the time varying equalizer can be implemented in the digital domain using, for example, a digital signal processor (DSP). In a DSP, an equalizer can be designed to have different time varying states. For example, different equalizer bandwidths may represent a different equalizer state.

If the time varying equalizer is analog, the equalizer can be placed after or before the analog filter. If the time varying equalizer is digital, the equalizer can be placed after an analog to digital converter (ADC) or after the signal is processed by a digital filter. In any of these configurations, at the beginning of a gain change, the initial state of the time varying equalizer can be configured in a previous state of an all-pass state such that the equalizer does not have significant effects on the system or another state, such as, for example, a power up or reset state. When the gain change is detected, the equalizer can be configured in a state that reduces, minimizes, or eliminates the transient effects from the gain change.

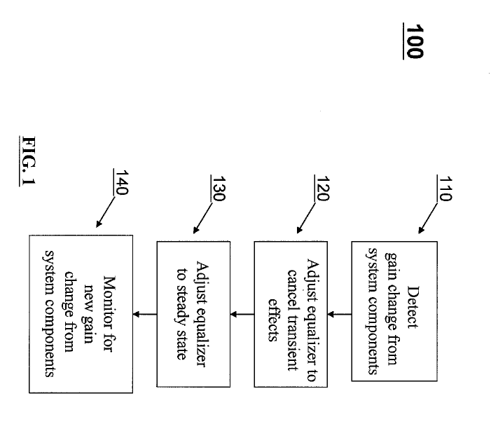

FIG. 1 is a block diagram of an example of a process 100 for adjusting a time varying equalizer to reverse or reduce a transient effect of a filter. The transient effect can cause distortion in a filtered signal when there is a gain change in a component such as an amplifier, a mixer, an x and/or a filter. When a gain change of such a component is detected by a control circuit or requested by a baseband (110), a time varying equalizer is adjusted to a different state (120) that cancels or reduces the filter transient effect and resulting signal distortion from a component's gain change. Next, the equalizer is, for example, gradually adjusted to a steady state (130) in which the equalizer acts as an all-band-pass filter to pass through the signal unchanged. The equalizer then stays at the steady state while it or another component monitors for a new gain change (140). The monitoring of system components for a gain change can be performed continuously, at specific intervals, or at specific circumstances. When a gain change is detected by, for example, a control circuit or a request from a baseband, process 100 is then repeated.

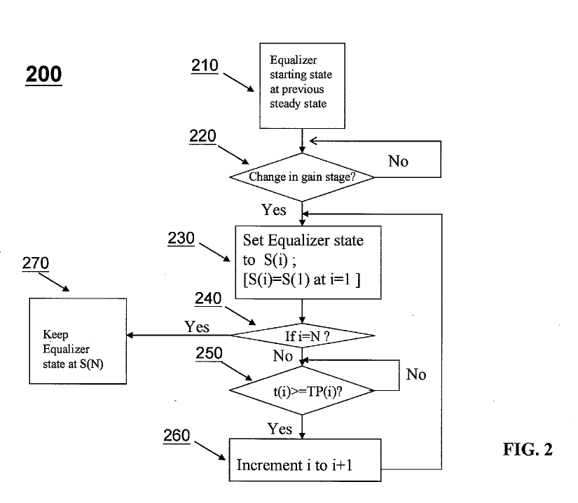

FIG. 2 is an example flow chart of a process 200 for adjusting a time varying equalizer. The process 200 begins with an equalizer's initial state at a steady state (210) from a previous system component gain change. In various implementations, the equalizer acts as an all-pass filter during the steady state such that a signal passes through the equalizer unchanged. Next, the previous gain of the gain stage is analyzed to determine whether a change in the gain stage has occurred (220). For example, an amplifier gain, such as that of an operational amplifier (Op-Amp) or an LNA, can be measured. Also, in various implementations, the baseband sends a gain change request to change the gain of a system component and the gain change request itself can be monitored to determine a change in the gain stage has occurred (220). If the gain has not changed, the process 200 does not continue and can wait for a change in situation. In one implementation, the Op-Amp or a LNA gain is measured constantly, in another implementation, the amplifier gain is measured only at specific intervals, for example, intervals related to the ADC sampling rate or to the input RF signal frequency or in specific circumstances, for example, as required by system specifications or instructed by the baseband.

If a gain change occurs or is detected (220), the equalizer's state is adjusted (230). In one implementation, the equalizer's state S(i) is adjusted (230) from a first state S(1) to a final, steady state S(N) in a series of discrete steps (e.g., i=2, 3, . . . N). Thus, at the beginning of the equalizer state adjustment process, the equalizer state can be set at S(1)(230). Next, the index “i” is compared to “N” (240). If i=N, the state can be kept at S(N) (270). If “i” is not equal to or greater than “N,” a time interval “t(i)” is compared to a value TP(i) of a time table, at “i” time period (250). If “t(i)” is not greater than the time interval specified at “i” time period TP(i) in the time-table, the process 200 does not continue and can wait for the time gets to the end of time period TP(i).

If “t(i)” is equal to or greater than the time interval TP(i) specified in the time table, “i” is incremented to “i”+1 and the process 200 iterates to adjust the equalizer for S(i=i+1) (230) until it reaches S(N) (270).

In general, the first state S(1) of the equalizer is set such that the equalizer reverses or reduces the transient effect of the filter that follows the gain stage. In the process 200, each change of state of the equalizer gradually changes the equalizer configuration such that the equalizer gradually transitions from canceling or reducing the transient effects of the filter to having little or no effect on the signal (e.g., an all-pass filter).

The above description is exemplary, and other timing and/or incrementing methods can be used. Moreover, the equalizer states S(i) and time tables are exemplary, and other methods can be used to store filter coefficient values or other values to be adjusted to affect the state of the equalizer. Also, referring to the processes 100 and 200, when a new component gain change is detected, the processes 100 and 200 can be in any point of equalization and can be terminated to start the processes 100 and 200 from the beginning.

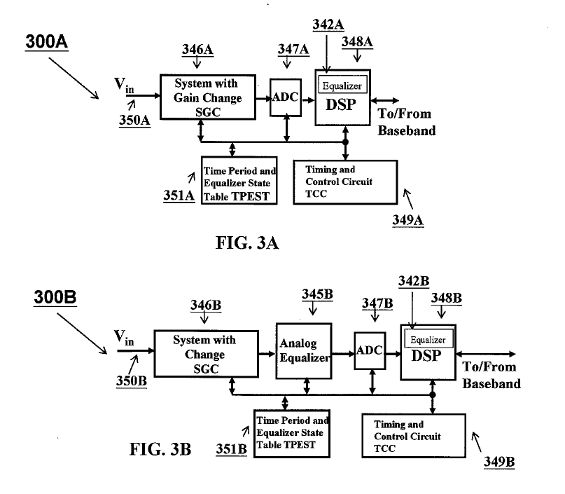

FIGS. 3A and 3B are schematics of examples of circuits 300A and 300B that employ the filter transient effect equalization techniques described above. The circuits 300A and 300B can be used to carry out the process 100 or process 200 described with respect to FIGS. 1 and 2.

The circuit 300A includes an RF signal 350A with a value Vᵢₙ received by a component or a system that employs a gain change (SGC) 346A such as an LNA, a mixer, an OP-Amp, a filter, an ADC or a combination of two or more of these components as in a receiver. The SGC 346A also includes a filter that has transient effects that induce signal distortion when there is a gain change. The output of the SGC 346A is digitized into digital signals by an ADC 347A with the digital output coupled to a DSP 348A to perform digital equalization functions with an embedded digital equalizer 342A. The DSP 348A is controlled by a timing and control circuitry (TCC) 349A with time period and equalizer state tables (TPEST) 351A.

The TCC 349A and TPEST 351A generally can be used in carrying out the processes 100 or 200. The TCC 349A can be programmed to implement process 100 or 200 with the TPEST 351A being used to provide the equalizer states (e.g. filter coefficients) and time period values. The baseband can send instructions to the TCC 349A via the DSP 348A or directly to change the gain of a component/components in the SGC 346A. Alternatively, or additionally, the TCC 349A or the DSP 348A can detect the component gain change and can initiate the process 100 or 200.

FIG. 3B is similar to FIG. 3A except that an analog equalizer 345B is used in addition to a digital equalizer 342B. Specifically, an analog equalizer 345B is placed between the SGC 346B and the ADC 347B in addition to the digital equalizer embedded in the DSP 348A after the ADC 347B. Analog equalizer 345B and digital equalizer 342B in the DSP 348B can be used together to reduce gain change transient effects of the filter/filters in the gain stage SGC 346B to reduce signal distortion. Additionally, or alternatively, the analog equalizer 345B can be used to cancel or reduce transient effects of filters in the SGC, while the digital equalizer 342B is used to reduce or cancel signal distortion due to gain change generated by the ADC 347B.

The disclosed techniques can be used with wireless communication systems. For example, the disclosed techniques can be used with receivers, transmitters, and transceivers, such as the receiver, transmitter, and/or transceiver architectures for superheterodyne receivers, image-rejection (e.g., Hartley, Weaver) receivers, zero-intermediate frequency (IF) receivers, low-IF receivers, direct-up transceivers, two-step up transceivers, and other types of receivers and transceivers for wireless and wireline technologies.

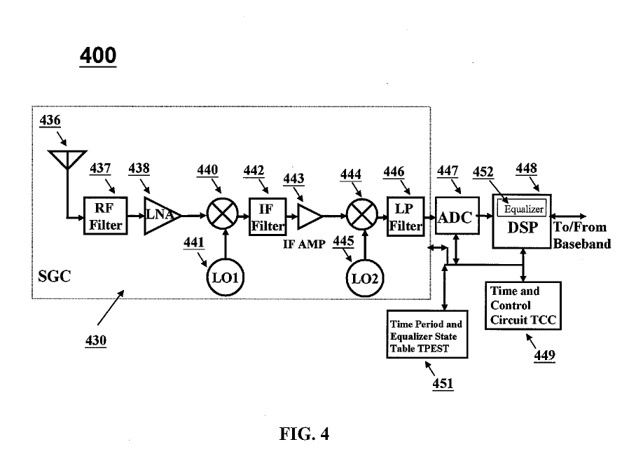

In particular, FIG. 4 is a schematic of an example of a low IF receiver 400 with an equalizer to reduce or cancel transient effects. An RF signal arriving at an antenna 436 passes through an RF filter 437, a low noise amplifier (LNA) 438, into a first mixer including an image filter 440, which translates the RF signal down to an intermediate frequency by mixing it with the signal produced by the first local oscillator (LO) 441. The undesired mixer products in the IF signal are rejected by an IF filter 442. The filtered IF signal then enters an IF amplifier stage 443, into a second mixer 444 that translates it down to yet another intermediate frequency by mixing it with the signal produced by a second LO 445.

The signal is then sent to a low-pass filter 446, an ADC 447, to a DSP 448, and then to the baseband for processing. Tuning into a particular channel within the band-limited RF signal is accomplished by varying the frequency of each LO 441 and 445. A TCC 449 is used to adjust the states of an equalizer 452 embedded in the DSP 448. In some implementations, the baseband can initial a component gain change for an amplifier gain through the DSP 448 or directly to the TCC 449.

The DSP 448 and the TCC 449 can be used to control the equalizer 452 using the techniques described above. In particular, for example, the TCC 449 can start the process 200 by setting a first equalization state S(1) with a state index “i”=1 to a first high-pass filter which can reverse or reduce the filter effects from the low-pass filter 446. The TCC 449 sets a first state of the equalizer 452 using a first set of filter coefficients from the TPEST 451 to the first high pass filter such that the combined low-pass filter 446 and high-pass filter act as an all-pass filter to an input signal. A final state step value “N” and a first time period TP(1) can also be obtained from the TPEST 451. In this example, “N” is 3. Next S(1) is checked against the final state step of“N”=3. Since S(1) is not yet the final state of S(3), the equalizer 452 remains in S(1) state until a first time in the first state t(1) is equal to or greater than the first time period TP(1). When t(1) becomes equal or greater than TP(1), the equalizer state index “i” is increased to “i”+1=2. Thereafter, the TCC 449 can set the equalizer 452 to a second state of S(2) which now can be a second high-pass filter with a lower gain than the first high-pass filter using a second set of filter coefficients from the TPEST 451.

The state S(2) is then checked against the final state step “N” and the equalizer 452 stays in the second state S(2) until a second time t(2) is equal to or greater than a second time period TP(2) from the TPEST 451. Since S(2) is not yet the final state, the process continues for a third state of the equalizer, S(3) In some implementations, state S(3) can implement an all-pass filter such that the received and filtered signal processed by components before the equalizer 452 can pass through the equalizer 452 with little or no change. S(3) is the final or steady state, so the equalizer 452 stays in S(3) until a new component gain change is detected in the system and the process repeats. In other implementations, the state “S(i)” of the equalizer 452 can have a plural number of parameters, such as, gain, frequency, slope, bandwidth or quality factor.

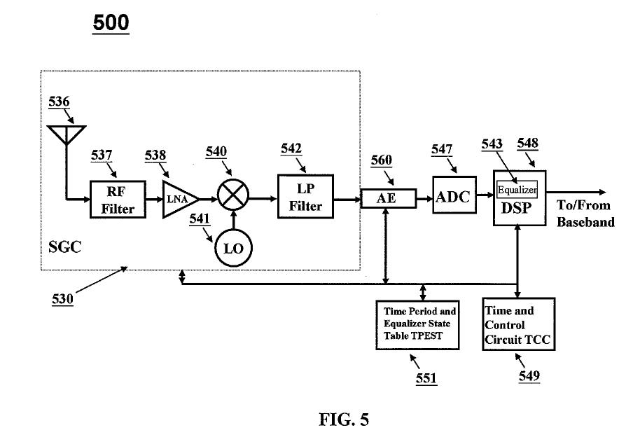

In another example, FIG. 5 is a schematic of a direct-conversion receiver 500 with equalizers. An antenna 536 couples a RF signal through a bandpass RF filter 537 into an LNA 538. The signal then enters a mixer 540 including an image filter and mixes with a LO frequency produced by a LO 541. The mixer output is then sent to a low-pass filter 542 to an analog equalizer 560. The equalized signal then enters an ADC 547 and is passed to a DSP 548 that implements a digital equalizer 543. The equalized signal is then sent to the baseband for use by the remainder of the communications system. The TCC 549 and TPEST 551 are used to adjust the equalizers 560 and 543, and, in particular, are used to adjust the equalizers 560 and 543 according to the techniques described above. The state of the analog equalizer 560 is adjusted to compensate for the transient effects resulting from low-pass filter 542, while digital equalizer 543 is adjusted to compensate for the transient effects of components between the analog equalizer 560 and the digital equalizer 543, such as ADC 547.

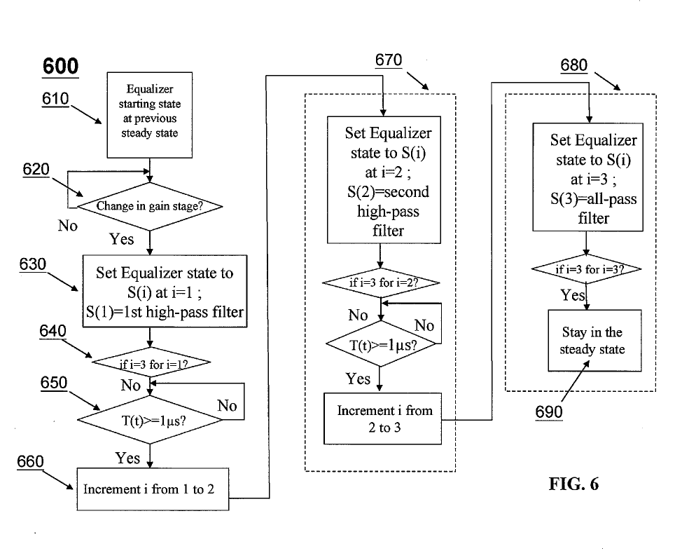

FIG. 6 is a more particular example of a process 600 for using a time varying equalizer. In process 600, the equalizer is adjusted from a first state that reduces initial transient effects from a gain change through multiple states to a final state in which the equalizer passes signals through substantially unchanged. In particular, process 600 employs three states (“N”=3). Initially the equalizer state is at a previous steady state (610). Various implementation may have a different number of iterations and/or states.

When a gain change is detected (620), the equalizer is set to a first equalization state S(1) using a first set of filter coefficients obtained from a filter coefficient table so that the equalizer operates as a first high-pass filter (630). The first high-pass filter is configured to reverse or reduce the transient response and signal distortion effects from a component used in processing a signal, such as a filter. In one example, a filter that generates the transient and signal distortion effects is a low-pass filter with a filter transfer function of −40 dB to 0 dB. The first high-pass filter can be configured to exhibit a filter transfer function of 0 dB to 40 dB with a steep slope. Therefore, the net filter effect of the low-pass filter and the high-pass filter is 0 dB.

Next, it is determined whether the counting variable “i” is at the final value of 3 (640). Specifically, whether “i” at its current value of i=1 is equal to 3 is determined. As 1 does not equal 3, the process continues on to check if the time period T(t) has expired (650). In particular, it is determined whether the value of the time period T(t) at time the current time value of “t” is equal or greater than a particular time period, for example, 1 μs as shown. If not, the equalizer state is maintained at S(1) until the end of, for example, 1 μs. The time period T(t) is checked against can be determined from a stored time table TP(i). For example if TP(1) has a value of 1 μs, the comparison of T(t) to TP(1) will determine whether T(t) is equal or greater than 1 μs. When T(t) is equal to or greater than 1 μs, the counting variable “i” is incremented by 1 to a value of 2 (660).

Thereafter, the process 600 is repeated for a second iteration (670) which includes similar features as elements 630-660. In the second iteration (670), a second equalizer state of S(2) is used. The second equalizer state uses a second set of filter coefficients obtained from the filter coefficient table to operate the equalizer as a second high-pass filter. At this time, the transient effects from the gain change may have partially subsided, but the low-pass filter transfer function can stay the same. Therefore, the second state of the equalizer can be changed without generating significant transient effects at the low-pass filter. In one example, the second state of the equalizer is set as a high-pass filter with a transfer function of 0 dB to 20 dB and with a less steep slope than the first high-pass filter. The net filter effect of the low-pass filter and the second high-pass filter approaches a low-pass filter of −20 dB to 0 dB.

As i=2 and therefore does not equal 3, the process 600 continues through the second iteration on to check if the time period T(t) has expired. The time period of, for example, 1 μs, for the second iteration (670) can be the same time period of the first iteration if, for instance, the bandwidth of input signals is constant. At the end of the second iteration (670), “i” is again incremented to a value of 3 and continues to a third iteration (680).

In the third iteration (680), a third equalizer state at S(3) is used. The third equalizer state uses a third set of filter coefficients obtained from the filter coefficient table to operate the equalizer as an all-pass filter with a transfer function of 0 dB. In the third iteration (680), the counting variable “i” does equal the final value of 3, so the counting variable “i” is set to i=1 and the process 600 can begin anew (690).

While the process 600 employs three states (“N”=3), a different number of states may be used. For example, other implementations may include a greater number of iterations with a greater number of equalizer states.

In some implementations, the positions of circuit components can be exchanged from the disclosed figures with minimal change in circuit functionality. Various topologies for circuit models can also be used. The exemplary designs shown can use various process technologies, such as CMOS or BiCMOS (Bipolar-CMOS) process technology, or Silicon Germanium (SiGe) technology. The circuits can be single-ended or fully-differential circuits. The types of equalizer circuits can include, for example, analog filters, high-pass, low-pass, band-pass and/or band-stop filters; digital filters: high-pass, low-pass, band-pass, band-stop, finite response (FIR) and/or indefinite response (IIR) filters.

The system can include other components. Some of the components can include computers, processors, clocks, radios, signal generators, counters, test and measurement equipment, function generators, oscilloscopes, phase-locked loops, frequency synthesizers, phones, wireless communication devices, and components for the production and transmission of audio, video, and other data. The number and order of variable gain and filter stages can vary. In addition the number of controllable steps, as well as the steps sizes of each of the stages of gain can also vary.

What is claimed is:

1. A method comprising:
receiving a signal at a device;
detecting a gain change in a component of the device that affects the signal;
in response to the detected gain change, adjusting a state of an equalizer to a first state that reduces transient effects introduced into the signal by one or more components in the device as a result of the gain change;
equalizing the signal using the equalizer with the state set to the first state; and
while equalizing the signal using the equalizer, adjusting the state of the equalizer from the first state to a second state, wherein the second state passes the signal through the equalizer substantially unchanged.

2. The method of claim 1 wherein the first and second states of the equalizer are associated with first and second sets of equalizer coefficients, respectively.

3. The method of claim 1 further comprising maintaining, before the detected gain change, the equalizer at an initial state, wherein the gain value of the first state is higher than a gain value of the initial state.

4. The method of claim 1 wherein the first and second states are determined from values stored in an equalizer state table.

5. The method of claim 1 wherein the first and second states are calculated dynamically.

6. The method of claim 1 wherein the equalizer is a digital filter.

7. The method of claim 1 wherein the equalizer is an analog filter.

8. The method of claim 1 wherein the first state of the equalizer reduces transient effects introduced into the signal by a filter before the signal is equalized by the equalizer.

9. The method of claim 1 wherein adjusting the state of the equalizer to the first state in response to the detected gain change includes detecting a gain change in a component that affects the signal continuously, at intervals, or at specific circumstances.

10. The method of claim 1 wherein detecting the gain change in the component that affects the signal comprises detecting a gain change instruction from a baseband.

11. The method of claim 1 wherein detecting the gain change in the component that affects the signal comprises monitoring the component that affects the signal for a change of gain.

12. The method of claim 1 wherein adjusting the state of the equalizer from the first state to a second state comprises:
maintaining the state at the first state for a first time period; and
maintaining the state at the second state until detecting a gain change in a component that affects the signal.

13. The method of claim 12 wherein adjusting the state of the equalizer from the first state to the second state further comprises:
adjusting the state from the first state to a first intermediate state;
maintaining the state at the first intermediate state for a second time period;
adjusting the state from the first intermediate state to a second intermediate state; and
maintaining the state at the second intermediate state for a third time period.

14. The method of claim 13 wherein the first, second, and third time periods are determined from values stored in a time period table.

15. The method of claim 1 wherein adjusting the state of the equalizer from the first state to a second state comprises:
adjusting the state to one or more intermediate states; and
adjusting the state from the one or more intermediate states to the second state, the one or more intermediate states having one or more gain values between a gain value of the first state and a gain value of the second state.

16. The method of claim 15 wherein the one or more intermediate states reduce transient effects which have a smaller magnitude than the transient effects reduced by the first state.

17. A system comprising:
an amplifier configured to amplify an input signal;
a filter coupled to the amplifier and configured to filter an amplified signal;
an equalizer coupled to an output of the filter; and
a control circuit configured to:
detect a gain change in the amplifier,
in response to the detected gain change, adjust a state of the equalizer to a first state that reduces transient effects introduced into the signal by one or more components as a result of the gain change, and
while the signal is equalized using the equalizer, adjust the state of the equalizer from the first state to a second state, wherein the second state passes the signal through the equalizer substantially unchanged.

18. The system of claim 17 wherein to adjust the state of the equalizer to the first state, the control circuit is configured to adjust the state from an initial state to the first state, wherein a gain value of the first state is higher than a gain value of the initial state.

19. The system of claim 18 wherein the adjustment of the state from the initial state to the first state is in response to a gain change being detected.

20. The system of claim 17 wherein to detect the gain change in the component that affects the signal, the control circuit is configured to detect a gain change instruction from a baseband.

21. The system of claim 17 wherein to detect the gain change in the component that affects the signal, the control circuit is configured to monitor the component that affects the signal for a change of gain.

22. The system of claim 17 wherein to detect the gain change in the component that affects the signal, the control circuit is configured to detect a gain change in the amplifier continuously, at intervals, or at specific circumstances.

23. The system of claim 17 wherein the control circuit is configured to:
adjust the state to one or more intermediate states comprising one or more intermediate gain values; and
adjust the state from the one or more intermediate states to the second state, wherein one or more intermediate gain values of the one or more intermediate states are between a gain value of the first state and a gain value of the second state.

24. The system of claim 23 wherein the one or more intermediate states reduce transient effects which have a smaller magnitude then the transient effects reduced by the first state.

25. The system of claim 17 wherein the control circuit is configured to:
maintain the state at the first state for a first time period; and
maintain the state at the second state until detecting a gain change in a component that affects the signal.

26. The system of claim 25 wherein the control circuit is configured to:
adjust the state from the first state to a first intermediate state;
maintain the state at the first intermediate state for a second time period;
adjust the state from the first intermediate state to a second intermediate state; and
maintain the state at the second intermediate state for a third time period.

27. The system of claim 26 wherein the control circuit is configured to determine the first, the second, and the third time periods from values stored in a time period table.

28. The system of claim 17 wherein the control circuit is configured to determine the first and second states from values stored in an equalizer state table.

29. The system of claim 17 wherein the first and second states of the equalizer are associated with first and second sets of filter coefficients, respectively.

30. The system of claim 17 wherein the equalizer is an analog filter.

31. A receiver comprising:
an antenna configured to receive a signal;
a radio frequency filter configured to filter the signal;
a low noise amplifier configured to amplify the filtered signal;
a mixer configured to mix output of the low noise amplifier;
an analog-to-digital converter configured to convert the signal after it has been mixed; and
a digital signal processor configured to receive the converted signal and configured to:
equalize the converted signal as a digital equalizer,
detect a gain change in a component that affects the signal,
in response to the detected gain change, adjust a state of the digital equalizer to a first state that reduces transient effects introduced into the signal by one or more components in the receiver as a result of the gain change, and
while the signal is equalized using the digital equalizer, adjust the state of the digital equalizer from the first state to a second state, wherein the second state passes the signal through the equalizer substantially unchanged.

32. The receiver of claim 31 wherein to adjust the state of the digital equalizer to the first state, the digital signal processor is configured to adjust the state from an initial state to the first state, wherein a gain value of the first state is higher than a gain value of the initial state.

33. The receiver of claim 31 wherein the digital signal processor is configured to:
adjust the state to one or more intermediate states comprising one or more intermediate gain values; and
adjust the state from the one or more intermediate states to the second state, the one or more gain values of the one or more intermediate states being between a gain value of the first state and a gain value of the second state.

34. The receiver of claim 33 wherein the one or more intermediate states reduce transient effects which have a smaller magnitude than the transient effects reduced by the first state.

35. The receiver of claim 33 wherein the digital signal processor is configured to determine the first and second states from values stored in an equalizer state table.

36. A method comprising:
receiving a signal at a device with an equalizer;
detecting a gain change in a component of the device that affects the signal;
in response to the detected gain change, adjusting a state of the equalizer to a first state;
equalizing the signal using the equalizer with the state set to the first state; and
while equalizing the signal using the equalizer, adjusting the state of the equalizer from the first state to a second state, wherein a gain value of the second state is less than a gain value of the first state.
